(19) United States
(12) Patent Application Publication
(10) Pub. No.: US 2015/0074548 A1
(43) Pub. Date: Mar. 12, 2015

(54) Information Sharing Method and Apparatus

(71) Applicant: Huawei Technologies Co., Ltd., Shenzhen (CN)

(72) Inventor: Fen Yang, Nanjing (CN)

(21) Appl. No.: 14/539,481

(22) Filed: Nov. 12, 2014

Related U.S. Application Data
(63) Continuation of application No. PCT/CN2012/087687, filed on Dec. 27, 2012.

(51) Int. Cl. H04L 12/18; G06F 3/0484; G06F 3/0482; H04L 12/58; G06F 3/0486

(52) U.S. Cl. CPC H04L 12/1813; H04L 51/046; G06F 3/0486; G06F 3/0482; G06F 3/04842
USPC 715/752; 715/753

(57) ABSTRACT

The present invention discloses an information sharing method and apparatus. The method according to an embodiment of the present invention includes receiving a shared resource dragged by a user into an information sharing field apparatus, extracting an information type of the shared resource, and acquiring attribute information of the shared resource according to the information type. The method further includes acquiring a target sharing user and a sharing mode; and invoking an interface corresponding to the sharing mode, and sending the shared resource to a terminal of the target sharing user according to the attribute information of the shared resource. A technical solution of the present invention can implement a uniform resource sharing application mode, and improve sharing convenience and user experience; and enable the use of different sharing modes in accordance with different resource types, implement sharing for a specific target user, and improve the time effectiveness, accuracy, and abundance of information sharing.

This application is a continuation of International Application No. PCT/CN2012/087687, filed on Dec. 27, 2012, which is hereby incorporated by reference in its entirety.

### TECHNICAL FIELD

The present invention relates to the field of communications and Internet technologies, and in particular, to an information sharing method and apparatus.

### BACKGROUND

Sharing has already been widely used in Internet applications for information exchange and interaction. Sharing is no longer limited to the distance, and a user can use a terminal to record every detail of the daily life and share the joyful experiences with others. A user can share resources on some application websites with friends over an SNS (social networking service) platform, for example, a user can send corresponding picture shared information on an album storage website to friends, and the friends can click the link of the shared information to visit the album.

In the prior art, a terminal provides multiple information sharing ways: after the terminal acquires new information (for example, takes a picture or installs an application), an application system asks whether to share the acquired information, and according to the selection of a user, shares the acquired information (for example, a picture or an application) to a service platform (for example, microblog or space); the terminal user selects a link address of a shared resource is selected, and a sharing mode is selected by using a “Share” menu of an application to implement resource sharing on the terminal. The information sharing ways on a terminal are diversified, some are system supported sharing, and some are sharing functions carried by applications; therefore, a user must select different sharing ways in different scenarios, and for different applications, the user further needs to memorize a sharing entry of each application, which affects the resource sharing efficiency of the terminal.

### SUMMARY

In view of the above, it is necessary to provide an information sharing method and apparatus, which are capable of improving the time effectiveness, accuracy, and abundance of information sharing.

In one aspect, an information sharing method is provided, which includes: receiving a shared resource dragged by a user into an information sharing field apparatus; extracting an information type of the shared resource, and acquiring attribute information of the shared resource according to the information type; acquiring a target sharing user and a sharing mode; and invoking an interface corresponding to the sharing mode, and sending the shared resource to a terminal of the target sharing user according to the attribute information of the shared resource.

In a first implementation manner of this aspect, the sharing field apparatus provides a uniform resource sharing application, and uses the uniform resource sharing application to implement sharing of one or more resource types.

In a second implementation manner of this aspect, the shared resource supports multiple resource types, including at least one of the following types: a locally installed application resource, a local text resource, a local multimedia resource, a network link resource, a network text resource, and a network multimedia resource.

In a third implementation manner of this aspect, the acquiring the target sharing user supports multiple acquiring modes, including at least one of the following modes: a manual input mode and an associated address book extraction mode.

In a fourth implementation manner of this aspect, the sharing mode supports multiple modes, including at least one of the following modes: a short message service (SMS) message mode, a multimedia messaging service (MMS) message mode, a push mode, an email mode, a microblog mode, a WeChat mode, and an arbitrary network platform contact mode.

In a fifth implementation manner of this aspect, the information sharing field supports display of a sharing state, including at least one of the following displayed states: sharing is ongoing, sharing is successful, and sharing fails.

In a sixth implementation manner of this aspect, the method further includes: supporting establishment of multiple information sharing fields, and when the multiple information sharing fields exist, supporting split-screen display of the multiple information sharing fields.

In a seventh implementation manner of this aspect, the method further includes: supporting presetting of a target sharing user and a sharing mode, storing the setting in an attribute of the information sharing field, and supporting naming of the information sharing field for distinguishing.

In an eighth implementation manner of this aspect, the method further includes: if the user does not select or set a sharing mode, using a default sharing mode of a system to send the shared resource.

In a ninth implementation manner of this aspect, the method further includes: supporting upload of a shared resource of a local type to a server, and acquiring from the server a URL in which the shared resource is stored.

In a tenth implementation manner of this aspect, the method further includes: supporting upload of a sharing operation record to a server, receiving a management operation from the server, and supporting query from the server a sharing history record.

In an eleventh implementation manner of this aspect, the method further includes: supporting cancellation of a current sharing operation in a manner of dragging the shared resource out of the information sharing field or deleting an icon of the shared resource in the information sharing field.

In a twelfth implementation manner of this aspect, the method further includes: if the sharing mode selected by the user does not exist or is not supported in information of the target sharing user, prompting that the sharing fails.

In another aspect, an information sharing system is provided, which includes an information sharing field apparatus and a server apparatus. The information sharing field apparatus is configured to receive a shared resource dragged by a user into the information sharing field apparatus; extract an information type of the shared resource, and acquire attribute information of the shared resource according to the information type; acquire a target sharing user and a sharing mode; and invoke an interface corresponding to the sharing mode, and send the shared resource to the target sharing user according to the attribute information of the shared resource. The server apparatus is configured to receive and store a shared resource, return a URL in which the shared resource is stored, receive and store a sharing operation record, and when the information sharing field apparatus puts forward a query request, return a sharing history record.

In another aspect, an information sharing field apparatus is provided, which includes: a shared resource receiving module, configured to receive a shared resource dragged by a user into the information sharing field apparatus, and display an icon of the shared resource in the information sharing field apparatus; a shared resource type determining module, configured to extract an information type of the shared resource, and acquire attribute information of the shared resource according to the information type; a target sharing user acquiring module, configured to acquire a target user in need of sharing, so as to enable the user to send shared information to the specific target user; a sharing mode acquiring module, configured to acquire a sharing mode, so as to enable the user to select different sharing modes according to requirements and preference; and an interface invoking module, configured to invoke an interface corresponding to the sharing mode, and send the shared resource to a terminal of the target sharing user according to the attribute information of the shared resource.

In a first implementation manner of this aspect, a sharing state display module is further included, which is configured to display a sharing state, including at least one of the following states: sharing is ongoing, sharing is successful, and sharing fails.

In a second implementation manner of this aspect, a sharing field setting module is further included, which is configured to create a sharing field, delete a sharing field, or set sharing field attribute information, where the sharing field attribute information includes a sharing field identifier, a target sharing user, a sharing mode, and a split-screen display background pattern.

In a third implementation manner of this aspect, a server interaction module is further included, which is configured to upload the shared resource to a server, and acquire from the server a URL in which the shared resource is stored; and is further configured to upload a sharing operation record to the server, and support query from the server a sharing history record.

In still another aspect, an information sharing field apparatus is provided, which includes a memory and a processor, where the memory is configured to store a shared resource; and the processor is configured to perform all or a part of the steps in the foregoing method.

An embodiment of the present invention has the following beneficial effects: Different from a situation in the prior art, in the embodiment of the present invention, a uniform resource sharing application can be provided by using an information sharing method, which implements sharing of different resource types and applications through a uniform sharing application entry, and improves sharing convenience and user experience; and enables the use of different sharing modes in accordance with different resource types, implements sharing for a specific target user, and improves the time effectiveness, accuracy, and abundance of information sharing.

### BRIEF DESCRIPTION OF THE DRAWINGS

To illustrate the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of an information sharing method according to Embodiment 1 of the present invention;

FIG. 2 is an effect diagram of an information sharing sending end according to Embodiment 1 of the present invention;

FIG. 3 is an effect diagram of an information sharing receiving end according to Embodiment 1 of the present invention;

FIG. 4 is another effect diagram of an information sharing receiving end according to Embodiment 1 of the present invention;

FIG. 5 is an effect diagram of an information sharing sending end according to Embodiment 2 of the present invention;

FIG. 6 is a schematic structural diagram of an information sharing field apparatus according to Embodiment 3 of the present invention;

FIG. 7 is a schematic structural diagram of an information sharing server according to Embodiment 4 of the present invention; and

FIG. 8 is a schematic structural diagram of an information sharing field apparatus according to an embodiment of the present invention.

### DETAILED DESCRIPTION OF ILLUSTRATIVE EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

An embodiment of the present invention provides an information sharing method, and an embodiment of the present invention further provides a corresponding information sharing field apparatus. Details are respectively given in the following steps.

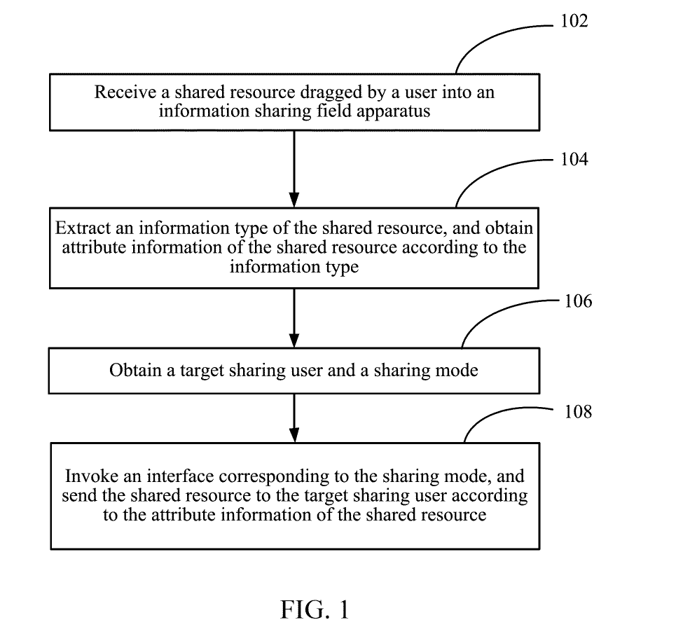

Referring to FIG. 1, a flowchart of an information sharing method according to Embodiment 1 of the present invention is shown, which includes the following steps.

Step 102: Receive a shared resource dragged by a user into an information sharing field apparatus. A uniform sharing application entry is provided, so as to enable the user to perform information sharing on a terminal through direct dragging.

Step 104: Extract an information type of the shared resource, and acquire attribute information of the shared resource according to the information type.

The information type of the shared resource may include a local resource type and a network resource type, where the local resource type is, for example, a locally installed application resource, a local text resource, or a local multimedia resource, and the network resource type is, for example, a network link resource, a network text resource, or a network multimedia resource.

The attribute information of the shared resource includes an icon, a thumbnail image, an application ID, a URL, and other information of the shared resource.

Step 106: Acquire a target sharing user and a sharing mode, where the user can select a target user or a target user group in need of sharing through a manual input mode or an associated address book extraction mode, and the user can select one or more sharing modes.

Step 108: Invoke an interface corresponding to the sharing mode, and send the shared resource to the target sharing user according to the attribute information of the shared resource.

According to the sharing mode selected by the user, a corresponding interface is invoked, and the acquired attribute information, including the URL, text, image, and icon link, of the shared resource is sent to the target sharing user to implement information sharing for the specific target user.

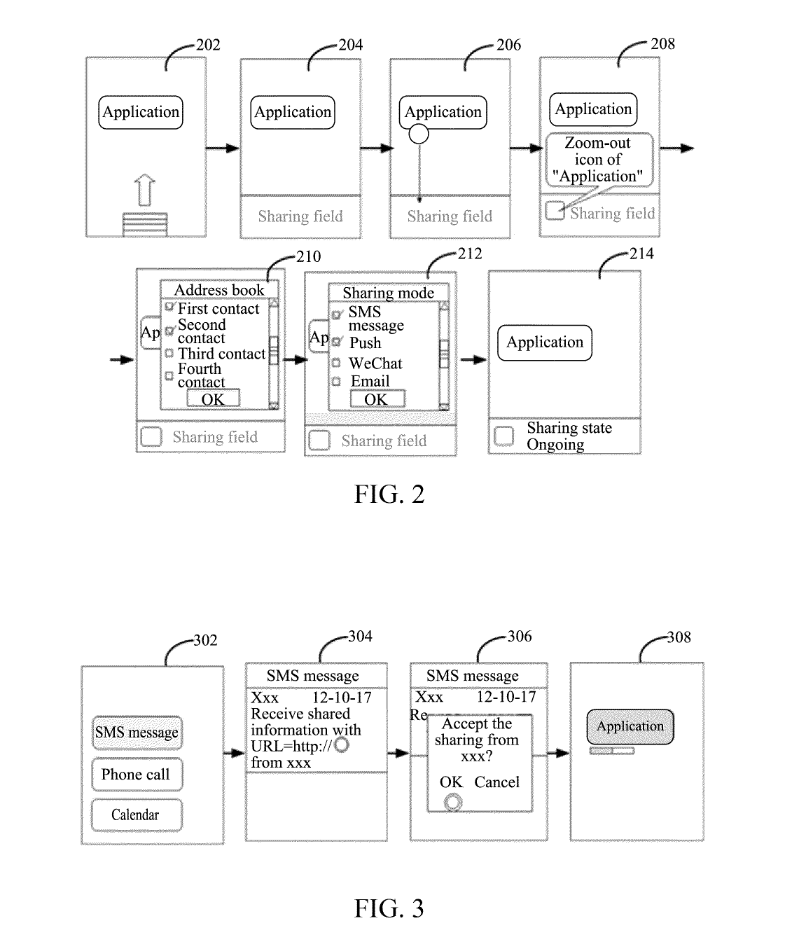

Referring to FIG. 2, an effect diagram of an information sharing sending end according to Embodiment 1 of the present invention is shown, which includes the following steps:

A mobile phone type terminal is taken as an example in this embodiment, and an effect diagram is used to illustrate a method and an apparatus for implementing an information sharing sending end:

Step 202: Receive an instruction of a user sharing a locally installed application of a mobile phone.

Step 204: Receive an instruction of the user opening an information sharing field application, and display an information sharing field window.

Step 206: Receive an instruction of the user dragging the application to be shared into the information sharing field, extract an information type of the shared resource, which is a locally installed application resource, and acquire attribute information, including a URL, an icon, and an application ID, of the application.

Step 208: Display the icon of the application resource that needs to be shared in the information sharing field, which indicates that the sharing request is accepted.

Step 210: Pop up a prompt box to require the user to select a target sharing user; and receive an instruction of the user selecting a target user or a target user group in need of sharing through a manual input mode or an associated address book extraction mode, where taking this embodiment as an example, the user selects a first contact and a second contact as target sharing users through the associated address book extraction mode.

Step 212: Pop up a prompt box to require the user to select a sharing mode, where the user may select one or more sharing modes, for example, a SMS message mode, a MMS message mode, a push (push) mode, an email (Email) mode, a microblog mode, a WeChat mode, and an arbitrary network platform contact mode. In this embodiment, the user selects the SMS message sharing mode and the push sharing mode.

Step 214: Implement resource and information sharing for the first contact and the second contact by using the SMS message mode and the push mode respectively, and the information sharing field displays the sharing state as sharing is ongoing; and after the sharing of the two modes is completed, the information sharing field displays the sharing state as sharing is successful.

A SMS message sending interface is invoked to send the attribute information (URL) of the application to be shared to the first contact and the second contact, so as to complete the information sharing.

The attribute information (icon, application id, URL) of the application, information of the target sharing users (mobile phone numbers of the first contact and second contact), and sender identifier information are sent to a Provider (a third-party service provider of push), and the Provider invokes a push interface to push the attribute information (icon, application id, URL) of the application to the contact 1 and contact 2.

Referring to FIG. 3, an effect diagram of an information sharing receiving end according to Embodiment 1 of the present invention is shown, where a target sharing user receives shared information in a SMS message mode, and the effect diagram includes the following steps:

Step 302: Terminals of target sharing users, namely, a first contact and a second contact, receive a SMS message.

Step 304: The SMS message displays that: Receive shared information with a URL, for example, http:// . . . , from XXX.

Step 306: The target sharing users select to accept the shared information.

Step 308: According to the URL, download an application to be shared to the terminal devices of the target sharing users, namely, the first contact and the second contact, to complete the resource and information sharing.

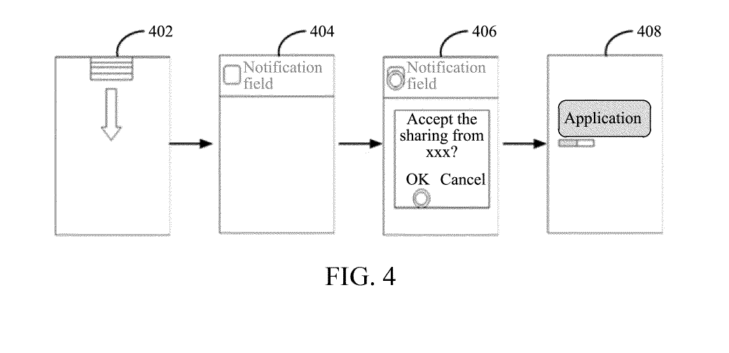

Referring to FIG. 4, another effect diagram of an information sharing receiving end according to an Embodiment 1 of the present invention is shown, where a target sharing user receives shared information in a push mode, and the effect diagram includes the following steps.

Step 402: A target sharing user terminal receives a push message prompt.

Step 404: The target sharing user terminal opens a push message notification field to display content of shared information.

Step 406: The target sharing user terminal selects to receive the shared information.

Step 408: According to a URL, download an application to be shared to the target sharing user terminal device to complete the resource and information sharing.

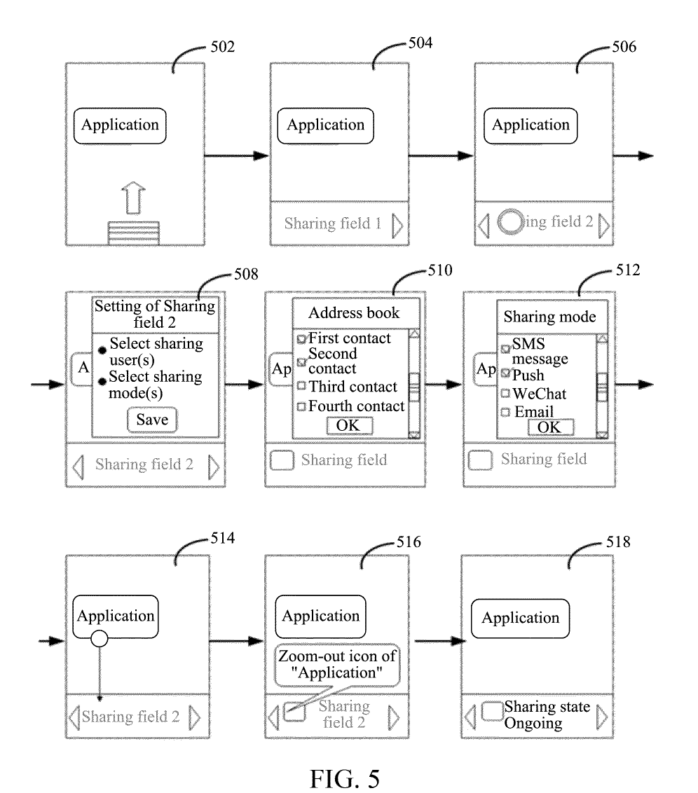

Referring to FIG. 5, an effect diagram of an information sharing sending end according to Embodiment 2 of the present invention is shown, this embodiment illustrates in detail the attribute setting of an information sharing field and displays functions of the information sharing field in a split-screen manner, and the effect diagram includes the following steps.

Step 502: Receive an instruction of a user opening an information sharing application.

Step 504: Display an information sharing field 1, where the information sharing application supports split-screen display of the information sharing field; and the split-screen display content includes the information sharing field 1 and an information sharing field 2.

Step 506: Slide to enter the information sharing field 2; according to an individual requirement of the user, attribute setting needs to be performed on the information sharing field 2, and slide to enter the information sharing field 2.

Step 508: Set attributes of the information sharing field, where the attribute setting of the information sharing field includes setting of a target sharing user, setting of a sharing mode, setting of a sharing field identifier, setting of a sharing field background pattern, and the like.

Step 510: Set a target sharing user of the information sharing field 2; and receive, by the information sharing application, an instruction of the user selecting a target user or a target user group in need of sharing through a manual input mode or an associated address book extraction mode, where taking this embodiment as an example, the user selects a first contact and a second contact as target sharing users through the associated address book extraction mode.

Step 512: Set a sharing mode of the information sharing field 2; and receive an instruction of the user selecting one or more sharing modes, for example, a SMS message mode, a MMS message mode, a push (push) mode, an email (Email) mode, a microblog mode, a WeChat mode, and an arbitrary network platform contact mode. In this embodiment, the user selects the SMS message sharing mode and the push sharing mode.

Step 514: The attribute setting of the information sharing field becomes valid after being acknowledged and saved, and in this embodiment, the user drags a local application as a shared resource into the information sharing field 2.

Step 516: Extract an information type of the shared resource, which is a locally installed application resource, acquire attribute information, including a URL, an icon, and an application ID, of the application, and display the icon in the information sharing field 2.

Step 518: According to the sharing modes (the SMS message mode and the push mode) set in the information sharing field 2, send the attribute information, such as the URL, of the shared application to the target sharing users (the first contact and the second contact) set in the information sharing field 2 to implement the resource and information sharing.

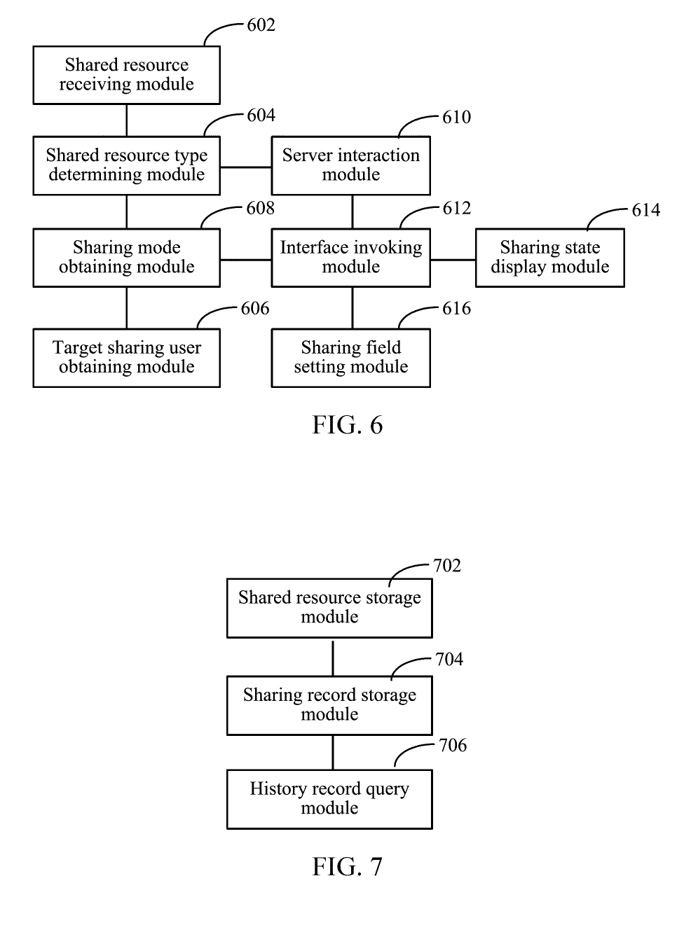

Referring to FIG. 6, a schematic structural diagram of an information sharing field apparatus according to Embodiment 3 of the present invention is shown, and the information sharing field apparatus includes the following modules. A shared resource receiving module 602 is configured to receive a shared resource dragged by a user into the information sharing field apparatus, and display an icon of the shared resource in the information sharing field apparatus. A shared resource type determining module 604 is configured to extract an information type of the shared resource, and acquire attribute information of the shared resource according to the information type; in this embodiment, it is taken as an example that the information type of the shared resource is multimedia data stored by the user terminal locally. A target sharing user acquiring module 606 is configured to acquire a target user in need of sharing, so as to enable the user to send shared information to the specific target user. A sharing mode acquiring module 608 is configured to acquire a sharing mode, so as to enable the user to select different sharing modes according to requirements and preference. A server interaction module 610 is configured to upload the shared resource to a server, and acquire from the server a URL in which the shared resource is stored; taking this embodiment as an example, a shared resource of a local multimedia data type is uploaded to a server, and a URL in which the shared resource is stored is acquired, so as to enable the shared resource type determining module to obtain complete attribute information of the shared resource. The server interaction module 610 is further configured to upload a sharing operation record to the server, and support query from the server a sharing history record; in another embodiment, the server interaction module 610 may further be configured to, after the user completes an information sharing operation, upload a record of the information sharing operation to the server for storage and management, where the record of the information sharing operation includes information of the shared resource, such as the attribute information, sharing time, the target sharing user, the sharing mode, and a sharing result, and when the user queries the sharing history record, receive and display information of the sharing history record returned by a client. An interface invoking module 612 is configured to invoke an interface corresponding to the sharing mode selected by the user, and send the acquired attribute information, including the URL, text, image, and icon link, of the shared resource to the target sharing user to implement information sharing for the specific target user. A sharing state display module 614 is configured to display a sharing state, including at least one of the following states: sharing is ongoing, sharing is successful, and sharing fails. A sharing field setting module 616 is configured to create a sharing field, delete a sharing field, or set sharing field attribute information, which includes setting of sharing field attributes such as a target sharing user, a sharing mode, a sharing field identifier, and a split-screen display background pattern.

Referring to FIG. 7, a schematic structural diagram of an information sharing server according to Embodiment 4 of the present invention is shown, and the information sharing server includes the following modules. A shared resource storage module 702 is configured to receive and store a shared resource, and return a URL in which the shared resource is stored. A sharing record storage module 704 is configured to receive and store a sharing operation record. Taking this embodiment as an example, the sharing record storage module 704 is configured to, after a user completes an information sharing operation, upload a record of the information sharing operation to the server for storage and management, where the record of the information sharing operation includes information of the shared resource, such as attribute information, sharing time, a target sharing user, a sharing mode, and a sharing result. A history record query module 706 is configured to manage an information sharing field apparatus, and when the information sharing field apparatus puts forward a query request, return a sharing history record; taking this embodiment as an example, a user initiates a sharing history record query request to the server in an information sharing field apparatus of a mobile phone terminal, and the server may return information of a sharing history record according to a query condition.

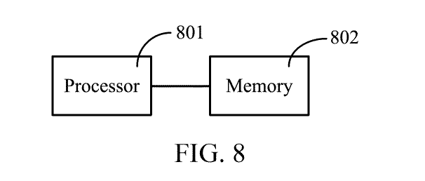

Referring to FIG. 8, an information sharing field apparatus according to an embodiment of the present invention includes: a processor 801 and a memory 802. The processor 801 is configured to perform all or a part of the steps in the foregoing method. The memory 802 is configured to store the shared resource.

In the several embodiments provided in the present application, it should be understood that the disclosed system, apparatus, and method may be implemented in other manners. For example, the described apparatus embodiment is merely exemplary. For example, the division of the modules or units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in a form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in a form of a software product. The computer software product is stored in a storage medium and includes several instructions for instructing a computer device (which may be a personal computer, a server, or a network device) or a processor (processor) to perform all or a part of the steps of the methods described in the embodiments of the present invention. The foregoing storage medium includes: any medium that can store program codes, such as a USB flash disk, a removable hard disk, a read-only memory (ROM), a random access memory (RAM), a magnetic disk, or an optical disk.

It should be noted that the foregoing embodiments are merely intended for describing the technical solutions of the present invention other than limiting the present invention. Although the present invention is described in detail with reference to the foregoing embodiments, a person of ordinary skill in the art should understand that modifications can still be made to the technical solutions described in the foregoing embodiments, or equivalent replacements can still be made to some technical features thereof, without departing from the spirit and scope of the technical solutions of the embodiments of the present invention.

What is claimed is:

1. An information sharing method comprising:
receiving a shared resource dragged by a user into an information sharing field apparatus;
extracting an information type of the shared resource, and acquiring attribute information of the shared resource according to the information type;
acquiring a target sharing user and a sharing mode; and
invoking an interface corresponding to the sharing mode, and sending the shared resource to a terminal of the target sharing user according to the attribute information of the shared resource.

2. The information sharing method according to claim 1, wherein the sharing field apparatus provides a uniform resource sharing application, and uses the uniform resource sharing application to implement sharing of one or more resource types.

3. The information sharing method according to claim 1, wherein the shared resource supports multiple resource types, comprising at least one of the following types: a locally installed application resource, a local text resource, a local multimedia resource, a network link resource, a network text resource, and a network multimedia resource.

4. The information sharing method according to claim 1, wherein the acquiring the target sharing user supports multiple acquiring modes, comprising at least one of the following modes:
a manual input mode and an associated address book extraction mode.

5. The information sharing method according to claim 1, wherein the sharing mode supports multiple modes, comprising at least one of the following modes: a short message service (SMS) message mode, a multimedia messaging service (MMS) message mode, a push mode, an email mode, a microblog mode, a WeChat mode, and an arbitrary network platform contact mode.

6. The information sharing method according to claim 1, wherein the information sharing field supports display of a sharing state, comprising at least one of the following displayed states:
sharing is ongoing, sharing is successful, and sharing fails.

7. The information sharing method according to claim 1, further comprising: supporting establishment of multiple information sharing fields, and when the multiple information sharing fields exist, supporting split-screen display of the multiple information sharing fields.

8. The information sharing method according to claim 1, further comprising: supporting presetting of a target sharing user and a sharing mode, storing the presetting in an attribute of the information sharing field, and supporting naming of the information sharing field for distinguishing.

9. The information sharing method according to claim 1, further comprising: if the user does not select or set a sharing mode, using a default sharing mode of a system to send the shared resource.

10. The information sharing method according to claim 1, further comprising: supporting upload of a shared resource of a local type to a server, and acquiring from the server a URL in which the shared resource is stored.

11. The information sharing method according to claim 1, further comprising: supporting upload of a sharing operation record to a server, receiving a management operation from the server, and supporting query from the server a sharing history record.

12. The information sharing method according to claim 1, further comprising: supporting cancellation of a current sharing operation in a manner of dragging the shared resource out of the information sharing field or deleting an icon of the shared resource in the information sharing field.

13. The information sharing method according to claim 1, further comprising: if the sharing mode selected by the user does not exist or is not supported in information of the target sharing user, prompting that the sharing fails.

14. An information sharing field apparatus, comprising: a memory and a processor, wherein the memory is configured to store a shared resource; and the processor is configured to perform the method according to claim 1.

15. An information sharing system, comprising: an information sharing field apparatus and a server apparatus, wherein
the information sharing field apparatus is configured to
receive a shared resource dragged by a user into the information sharing field apparatus;
extract an information type of the shared resource, and acquire attribute information of the shared resource according to the information type;
acquire a target sharing user and a sharing mode; and
invoke an interface corresponding to the sharing mode, and send the shared resource to the target sharing user according to the attribute information of the shared resource; and
the server apparatus is configured to receive and store a shared resource, return a URL in which the shared resource is stored, receive and store a sharing operation record, and when the information sharing field apparatus puts forward a query request, return a sharing history record.

16. An information sharing field apparatus comprising:
a shared resource receiving module, configured to receive a shared resource dragged by a user into the information sharing field apparatus, and display an icon of the shared resource in the information sharing field apparatus;
a shared resource type determining module, configured to extract an information type of the shared resource, and acquire attribute information of the shared resource according to the information type;
a target sharing user acquiring module, configured to acquire a target user in need of sharing, so as to enable the user to send shared information to the target user;
a sharing mode acquiring module, configured to acquire a sharing mode, so as to enable the user to select different sharing modes according to requirements and preference; and
an interface invoking module, configured to invoke an interface corresponding to the sharing mode, and send the shared resource to a terminal of the target sharing user according to the attribute information of the shared resource.

17. The information sharing field apparatus according to claim 16, further comprising: a sharing state display module, configured to display a sharing state, comprising at least one of the following states: sharing is ongoing, sharing is successful, and sharing fails.

18. The information sharing field apparatus according to claim 16, further comprising: a sharing field setting module, configured to create a sharing field, delete a sharing field, or set a sharing field attribute information, wherein the sharing field attribute information comprises a sharing field identifier, a target sharing user, a sharing mode, and a split-screen display background pattern.

19. The information sharing field apparatus according to claim 16, further comprising: a server interaction module, configured to upload the shared resource to a server, and acquire from the server a URL in which the shared resource is stored; and further configured to upload a sharing operation record to the server, and support query from the server a sharing history record.
